(19) United States
(12) Patent Application Publication
(10) Pub. No.: US 2026/0300070 A1
(43) Pub. Date: Oct. 1, 2026

(54) SUPPORT DEVICE, SUPPORT METHOD, AND RECORDING MEDIUM

(71) Applicant: NEC Corporation, Tokyo (JP)

(72) Inventors: Toshihiko IMAI, Tokyo (JP); Marina ADACHI, Tokyo (JP); Shingo MORIGAKI, Tokyo (JP); Wataru TAKAYANAGI, Tokyo (JP); Kentaro MAEDA, Tokyo (JP)

(73) Assignee: NEC Corporation, Tokyo (JP)

(21) Appl. No.: 19/567,633

(22) Filed: Mar. 16, 2026

(30) Foreign Application Priority Data
Mar. 28, 2025 (JP) 2025-054979

(51) Int. Cl. G06F 11/07

(52) U.S. Cl. CPC G06F 11/0769; G06F 11/0724

(57) ABSTRACT

A support device includes failure information acquisition unit for acquiring an error message output from a system in which a failure is occurring, output information generation unit for generating output information by inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term, and output unit for outputting the output information.

This application is based upon and claims the benefit of priority from Japanese Patent Application No. 2025-054979, filed on Mar. 28, 2025, the disclosure of which is incorporated herein in its entirety by reference.

### TECHNICAL FIELD

The present disclosure relates to a support device, a support method, and are recording medium.

### BACKGROUND ART

There has been known a technology for supporting, at the time of occurrence of a system failure, a user in grasping information regarding the failure. For example, with the technology disclosed in JP 2004-348730 A, if a failure is detected in an application in execution, characteristics of an application, characteristics of the failure, and a software configuration and a hardware configuration of a computer in which the failure has occurred are collected, and a cause of the system failure is identified using an artificial intelligence algorithm.

### SUMMARY

An object of the present disclosure is to provide a support device, a support method, and a recording medium that support, at time of occurrence of a system failure, a user without specialized knowledge in grasping an impact expected if the failure continues.

A support device of an aspect of the present disclosure includes failure information acquisition means for acquiring an error message output from a system in which a failure is occurring, output information generation means for generating output information by inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term, and output means for outputting the output information.

A support method of an aspect of the present disclosure is executed by a computer and includes acquiring an error message output from a system in which a failure is occurring, inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term, acquiring, as output information, information output from the generative model, and outputting the output information.

A computer program of an aspect of the present disclosure causes a computer to execute processing including acquiring an error message output from a system in which a failure is occurring, generating output information by inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term, and outputting the output information.

### BRIEF DESCRIPTION OF THE DRAWINGS

Exemplary features and advantages of the present disclosure will become apparent from the following detailed description together with the accompanying drawings in which:

FIG. 1 is a conceptual diagram for explaining an overview of a support system in the present disclosure;

FIG. 2 is a block diagram illustrating an example of a configuration of a support device in the present disclosure;

FIG. 3 is a flowchart illustrating an example of an operation of the support device in the present disclosure;

FIG. 4 is a block diagram illustrating an example of the configuration of the support device in the present disclosure;

FIG. 5 is a diagram illustrating an example of a correction request screen in the present disclosure;

FIG. 6 is a flowchart illustrating an example of the operation of the support device in the present disclosure;

FIG. 7 is a block diagram illustrating an example of the configuration of the support device in the present disclosure;

FIG. 8 is a flowchart illustrating an example of the operation of the support device in the present disclosure; and

FIG. 9 is a diagram illustrating an example of a hardware configuration in which the support device in the present disclosure is achieved by a computing device including a processor.

### EXAMPLE EMBODIMENT

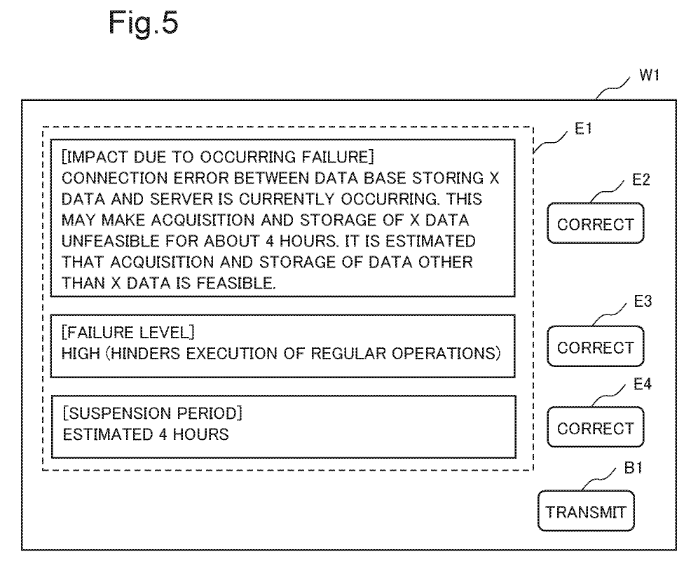

Hereinafter, example embodiments in the present disclosure will be described in detail while referring to the drawings. The example embodiments described below have technically preferable limitations for carrying out the present disclosure; however, it is not intended to limit the scope of the invention to the following. In all the drawings used in the following description of the example embodiments, the same reference signs are given to similar sections unless otherwise specified. In the following example embodiments, repeated description of similar configurations and operations is omitted in some cases. A user interface (UI) illustrated in FIG. 5 is an example, and may be replaced with another UI.

### First example embodiment

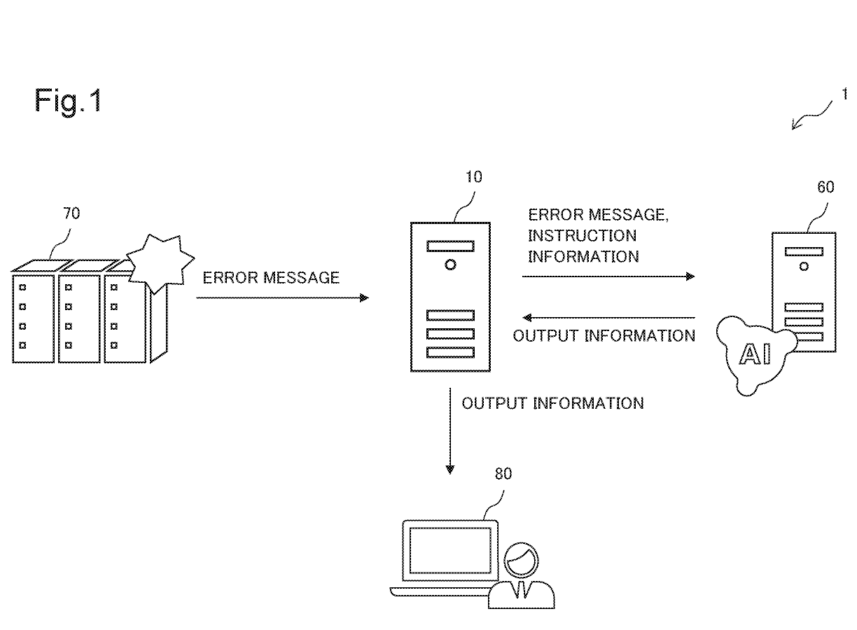

First, an overview of a support system in a first example embodiment will be described while referring to some drawings. FIG. 1 is a conceptual diagram for explaining the overview of the support system in the present disclosure. An overview of a processing flow of a support system 1 will be described with reference to FIG. 1.

If a failure occurs in a system 70, a support device 10 acquires an error message from the system 70. In FIG. 1, the error message is acquired from the system 70; however, the error message may be acquired from a user terminal 80 or a monitoring device (not illustrated) of the system 70. The support device 10 generates output information by inputting the error message and instruction information to a generative model that is stored in a server 60. The instruction information is a prompt to be input to the generative model. The instruction information includes three instructions. A first instruction is an instruction to predict, from the error message, an impact caused by the failure on a service provided by a monitoring target system. A second instruction is an instruction to generate, from the error message and a result of the prediction by the first instruction, text explaining the impact on the service caused by the failure. A third instruction is an instruction to change a specialized term contained in the text to a general term. In other words, the third instruction is one instructing not to contain a specialized term in the output information. The generative model generates the output information in response to the input from the support device 10 and outputs the output information to the support device 10. The support device 10 acquires the output information that is output from the generative model. In this manner, the support device 10 generates the output information by inputting the error message and the instruction information to the generative model. The support device 10 outputs the generated output information to the user terminal 80.

The server 60 is a server that stores and executes the generative model. The server 60 is not limited to a server as long as it is an information processing device capable of achieving this function. The generative model is, for example, a large language model (LLM). In the present example embodiment, the server 60 and the support device 10 are illustrated as separate configurations; however, these are not limited thereto. The support device 10 may have the function of the server 60.

The system 70 is a system that provides one or a plurality of the services to the user terminal 80. For example, if the system is an online conference system, the provided service includes a video conference service, an audio conference service, a screen sharing service, a chat service, and the like. In another example, if the system is a production management system, the provided service includes a production planning service, an inventory management service, a quality control service, a facility operation monitoring service, a procurement management service, and the like. The system and the services may each be of any type, and are not limited to the above examples. The system 70 is achieved by a server, network equipment, a storage device, software, or a combination of these. If the failure occurs in hardware or software of the system 70, the error message indicating a failure situation is output.

The user terminal 80 is a terminal device operated by a user. For example, the user terminal 80 is achieved by a stationary terminal device, a portable terminal device, or a general-purpose information processing device, such as a server. In the example of FIG. 1, the number of the user terminals 80 is one, but may be a plurality of user terminals.

### Configuration

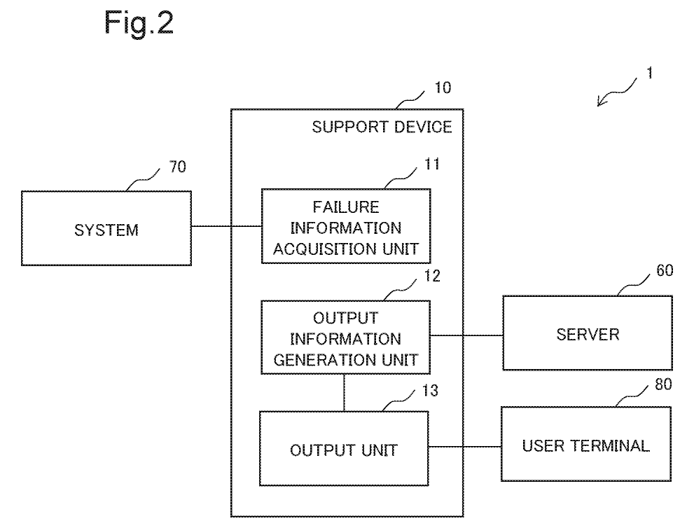

Next, a configuration of the support device will be described using FIG. 2. FIG. 2 is a block diagram illustrating an example of the configuration of the support device in the present disclosure.

The support device 10 is achieved by a general-purpose information processing device, such as a stationary terminal device, a portable terminal device, and a server device. As illustrated in FIG. 2, the support device 10 is communicably connected to each of the server 60, the system 70, and the user terminal 80.

As illustrated in FIG. 2, the support device 10 includes a failure information acquisition unit 11, an output information generation unit 12, and an output unit 13.

The failure information acquisition unit 11 acquires failure information that is information regarding the failure occurring in the system. The failure information acquisition unit 11 acquires the failure information from at least one of the system 70 and the user terminal 80. The failure information contains the error message output from the system in which the failure is occurring.

The failure information may further contain monitoring data. The monitoring data is data collected by monitoring a resource that is a monitoring target in the system 70. The collection of the monitoring data is performed by, for example, the monitoring device (not illustrated) of the system 70. For example, the monitoring data is data regarding an operating condition, performance, and an environment of the system 70. More specifically, the monitoring data contains a resource usage status, log information of an application etc., a performance index, setting information and a setting change history, a state of a dependent service, a network state, physical environment information on humidity of an installation place etc., a backup state, and the like. The failure information acquisition unit 11 may acquire the monitoring data, as the failure information, from the monitoring device of the system 70 and/or the user terminal 80.

The output information generation unit 12 generates the output information by inputting the error message and the instruction information to the generative model. The instruction information is a prompt to be input to the generative model. The instruction information includes at least the first instruction, the second instruction, and the third instruction.

The first instruction is the instruction to predict, from the error message, the impact caused by the failure on the service provided by the monitoring target system. For example, the first instruction is instruction information, such as "Analyze the error message regarding the failure and predict how this failure can affect the service provided by the system.”. The first instruction may further contain a specific instruction on information to be predicted. For example, the first instruction may contain an instruction to predict a suspension period indicating a period during which the service is unavailable due to the failure. For example, the first instruction may further contain instruction information, such as “For example, predict a suspension period indicating a period during which the service is expected to be unavailable due to the failure.”. In another example, if there are a plurality of the services provided by the system 70, the first instruction may contain an instruction to predict a service that becomes unavailable due to the failure and a service that is still available while the failure is arising. For example, the first instruction may further contain instruction information, such as “For example, predict a service that becomes unavailable due to this failure and a service that is available.”

The second instruction is the instruction to generate, from the error message and the result of the prediction by the first instruction, the text explaining the impact on the service caused by the failure. For example, the second instruction is instruction information, such as “Create text briefly explaining the impact of the failure on the service, based on the error message and the result predicted earlier.”

The third instruction is the instruction to change the specialized term contained in the text to a general term. In other words, the third instruction is one instructing not to contain a specialized term in the output information. For example, the third instruction is instruction information, such as “Replace the specialized term contained in the generated text with a general term easy to understand for a user without specialized knowledge about the system.”. Alternatively, the third instruction may be instruction information, such as “Do not contain in the generated text any specialized term unfamiliar to the user without specialized knowledge about the system.”. The third instruction may also contain an instruction to make the change within a range not impairing accuracy of original text. For example, the third instruction may contain instruction information, such as “Do not impair the technical accuracy in making a change.”. In another example, the third instruction may contain an instruction to output a specialized term before being subjected to the change. For example, the third instruction may contain instruction information, such as “Upon changing a term, show the term before the change in parentheses following the term after the change.”

The input information to the generative model may further contain information other than the error message and the instruction information. For example, if the failure information acquisition unit 11 acquires the monitoring data as the failure information, the monitoring data may be further input to the generative model. If the monitoring data is input to the generative model, the first instruction results in an instruction to predict, further based on the monitoring data, the impact on the service caused by the failure. The second instruction results in an instruction to generate, further based on the monitoring data, the text explaining the impact on the service caused by the failure.

The instruction information may also include an instruction other than the first instruction, the second instruction, and the third instruction. For example, the instruction information may further include a fourth instruction that is an instruction to predict a state of each resource of the system 70 in which the failure is arising. For example, the fourth instruction is instruction information, such as “Analyze the error message and show the present estimated state and the predicted future state for each resource of the system in which failure is occurring”.

In another example, the instruction information may further include a fifth instruction that is an instruction to predict a failure level indicating a level of the failure that is occurring.

For example, the failure level contained in the fifth instruction is determined according to a ratio of the number of services that become unavailable due to the failure to the total number of the services provided by the system 70. For example, the higher the proportion of the services that become unavailable due to the failure, the higher the failure level, while the lower the proportion of the services that become unavailable, the lower the failure level.

In another example, the failure level contained in the fifth instruction is determined according to a length of the suspension period indicating the period during which the service provided by the system 70 is expected to be unavailable. For example, the longer the suspension period, the higher the failure level, while the shorter the suspension period, the lower the failure level.

In still another example, the instruction information may further include a sixth instruction that is an instruction to predict where liability for the current failure lies. In this case, the input information input to the generative model further contains additional information, such as a contract document and a design document concerning the system 70. For example, the sixth instruction is an instruction to perform, by comparing the additional information with the prediction result by the first instruction, prediction of whether the current failure is within an extent of liability of a system provider. For example, the sixth instruction is instruction information, such as "Compare the content of the service level agreement (SLA) described in the contract document with the result predicted earlier. Then, determine whether there is a possibility that the current failure constitutes a breach of the SLA.”. For example, the sixth instruction may contain an instruction to perform prediction of where the liability lies, according to whether time until failure recovery defined in the SLA is within the suspension period. The sixth instruction may also contain an instruction to perform prediction of where the liability lies, according to whether the cause of the failure is within the extent of liability of the system provider.

The output information generation unit 12 inputs these pieces of input information to the generative model. The output information generation unit 12 then generates the output information output from the generative model in response to the input of the input information. The output information generation unit 12 generates the output information in this manner.

The output unit 13 outputs the generated output information. For example, the output unit 13 outputs the generated output information to the user terminal 80. An output destination of the output information by the output unit 13 is not limited to the user terminal 80.

### Operation

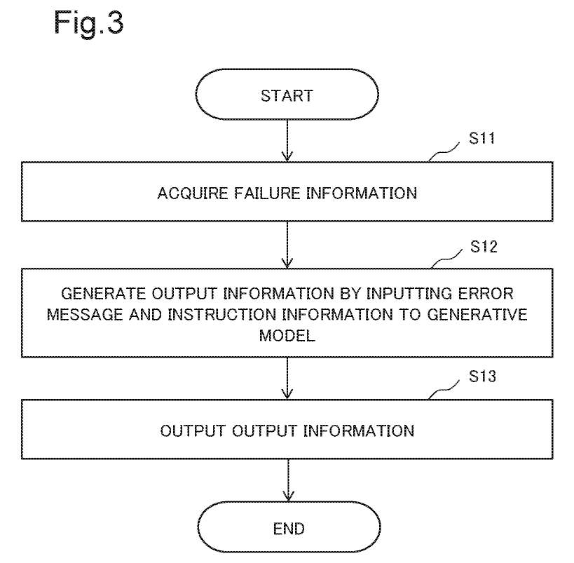

Next, an operation of the support device 10 in the present example embodiment will be described while referring to FIG. 3. FIG. 3 is a flowchart illustrating an example of the operation of the support device in the present disclosure.

First, the failure information acquisition unit 11 acquires the failure information that is the information regarding the failure occurring in the system (step S11). The failure information contains the error message output from the system 70 that is the system in which the failure is occurring. The failure information may further contain the monitoring data acquired from the monitoring device of the system 70.

Next, the output information generation unit 12 generates the output information by inputting the error message and the instruction information to the generative model (step S12). The instruction information includes at least the first instruction, the second instruction, and the third instruction. The first instruction is the instruction to predict, from the error message, the impact caused by the failure on the service provided by the monitoring target system. The second instruction is the instruction to generate, from the error message and the result of the prediction by the first instruction, the text explaining the impact on the service caused by the failure. The third instruction is the instruction to change the specialized term contained in the text to the general term. In other words, the third instruction is one instructing not to contain the specialized term in the output information. The output information generation unit inputs these to the generative model, thereby acquiring, as the output information, the information output from the generative model.

The output unit 13 outputs the output information generated in step S12 (step S13). After the processing of step S13 is finished, the support device 10 ends the series of processing described above.

As described above, the support device of the present example embodiment includes the failure information acquisition unit, the output information generation unit, and the output unit. The failure information acquisition unit acquires the error message output from the system in which the failure is occurring. The output information generation unit generates the output information by inputting the error message, the first instruction, the second instruction, and the third instruction to the generative model. The first instruction is the instruction to predict, from the error message, the impact caused by the failure on the service provided by the system. The second instruction is the instruction to generate, from the error message and the result of the prediction, the text explaining the impact on the service caused by the failure. The third instruction is the instruction to change the specialized term contained in the text to the general term. The output unit outputs the output information.

The output information generated by the support device of the present example embodiment contains the text based on the prediction result of the impact caused by the failure on the service provided by the system. The output information does not contain a specialized term in accordance with the instruction to change the specialized term contained in the text to the general term. This enables the support device of the present example embodiment to support, at the time of the occurrence of the system failure, the user without specialized knowledge in grasping the impact expected if the failure continues.

If the failure occurs, an error message is issued from a system. In general, the error message contains information to help grasp the present situation of the failure, while often not containing prediction information regarding an impact expected if the failure continues. In general, interpretation of the error message also requires specialized knowledge. Hence, at the time of the occurrence of the failure, it is difficult for users without specialized knowledge to immediately grasp an impact on their work due to continuation of the failure. There is also a demand that, at the time of the occurrence of the failure, users without specialized knowledge grasp the impact expected if the failure continues.

According to the present disclosure, the support device, the support method, and the computer program can be provided that support, at the time of the occurrence of the system failure, a user without specialized knowledge in grasping the impact expected if the failure continues.

In the support device of an aspect of the present example embodiment, the first instruction further contains the instruction to predict the suspension period indicating the period during which the service is unavailable due to the failure. This enables the user to grasp a specific period during which the service is unavailable, which makes it possible to grasp a period during which the user cannot perform his/her work due to the failure. In other words, according to the support device of the aspect of the present example embodiment, it is possible to support the user in grasping the impact expected if the failure continues.

In the support device of an aspect of the present example embodiment, the number of the services provided by the system is a plurality of services. The first instruction further contains the instruction to predict the service that becomes unavailable due to the failure and the service that is still available while the failure is arising. This enables the user to grasp whether a service relevant to his/her work is affected by the failure. In other words, according to the support device of the aspect of the present example embodiment, it is possible to support the user in grasping the impact expected if the failure continues.

In the support device of an aspect of the present example embodiment, the failure information acquisition unit further acquires the monitoring data collected by monitoring the resource being the monitoring target in the system. In this case, the first instruction is the instruction to predict, further based on the monitoring data, the impact on the service caused by the failure. In this case, the second instruction is the instruction to generate, further based on the monitoring data, the text explaining the impact on the service caused by the failure. According to the support device of the aspect of the present example embodiment, it is possible to improve accuracy of the prediction by performing the prediction further using the monitoring data as well as the error message.

In the support device of an aspect of the present example embodiment, the output information generation unit generates the output information by further inputting, to the generative model, the contract document concerning the system, and the instruction to perform, by comparing the content of the contract document with the prediction result by the first instruction, the prediction of whether the failure is within the extent of liability of the provider of the system. This enables the user to clearly identify the extent of liability of the provider of the system. For example, in a case where the user is a sales representative of an organization that provides the system, the user can grasp at an early stage whether there is a possibility that the current failure constitutes a breach of a contractual obligation, which makes it possible to take measures at an early stage. In other words, according to the support device of the aspect of the present example embodiment, it is possible to support the user in grasping the impact expected if the failure continues.

### Second example embodiment

Next, description will be given regarding a support device according to the present example embodiment, with reference to some of the drawings. In the following description, the same reference signs are given to similar parts to those of the first example embodiment, and description thereof will be omitted as appropriate. The support device of the present example embodiment differs from the support device of the first example embodiment in further including a model adjustment unit that tunes a generative model, a determination unit that determines whether to output output information to a user, and an input request unit that accepts an input of a correction of the output information.

### Configuration

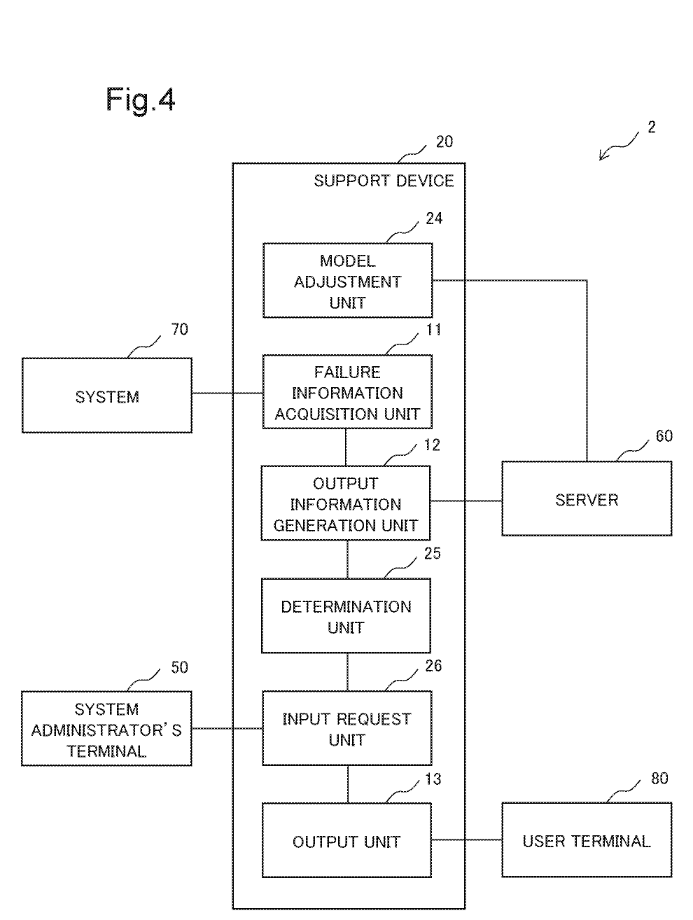

FIG. 4 is a block diagram illustrating an example of the configuration of the support device in the present disclosure. As illustrated in FIG. 4, a support device 20 of support system 2 includes a failure information acquisition unit 11, an output information generation unit 12, an output unit 13, a model adjustment unit 24, a determination unit 25, and an input request unit 26.

The model adjustment unit 24 tunes the generative model using training data. The training data is data generated using cases of past system failures. The training data is data in which error messages issued at the time of occurrence of the past failures are associated with information regarding impacts caused by the failures on a service provided by a system. The information regarding the impacts caused by the failures on the service provided by the system includes, for example, suspension periods during which the service was unavailable due to the failures, information indicating a service that became unavailable due to the failures, and information indicating a service that was still available while the failures arose. The tuning is, for example, fine-tuning and/or instruction tuning. The model adjustment unit 24 may further perform tuning of instruction information used by the output information generation unit 12 by using these pieces of training data.

The determination unit 25 determines whether to output the output information to a user terminal 80 according to a level of an occurring failure. If the level of the failure is contained in the output information generated by the output information generation unit 12, the determination unit 25 refers to the level of the failure. For example, if the level of the occurring failure is a predetermined threshold or more, the determination unit 25 determines to output the output information to the user terminal 80. If the level of the occurring failure is less than the predetermined threshold, the determination unit 25 determines not to output the output information to the user terminal 80.

The input request unit 26 accepts the input of the correction of the output information generated by the output information generation unit 12. For example, the input request unit 26 outputs the output information to a system administrator’s terminal 50 and requests the input of the correction of the output information. The input request unit 26 may request an input of a correction for a determination result of the determination unit 25. The system administrator’s terminal 50 is an information processing device operated by an administrator or a provider of a system 70.

For example, the input request unit 26 requests the input of the correction of the output information by displaying an input interface, such as a web browser, on a display unit of the system administrator’s terminal 50. FIG. 5 is a diagram illustrating an example of a correction request screen in the present disclosure. For example, the input request unit 26 causes the display unit of the system administrator’s terminal 50 to display the input interface appearing on a correction request screen W1. The correction request screen W1 includes output information E1, and UI components E2 to E4 that request the input of the correction of the output information. For example, if there is an item to be corrected in the output information E1, the system administrator presses any of the UI components E2 to E4 and inputs a correction content. Upon completing the input of the correction content, the system administrator presses a button B1. If it is detected that the button B1 is pressed, the system administrator’s terminal 50 transmits the input information to the support device 20. The input request unit 26 acquires the information transmitted from the system administrator’s terminal 50.

### Operation

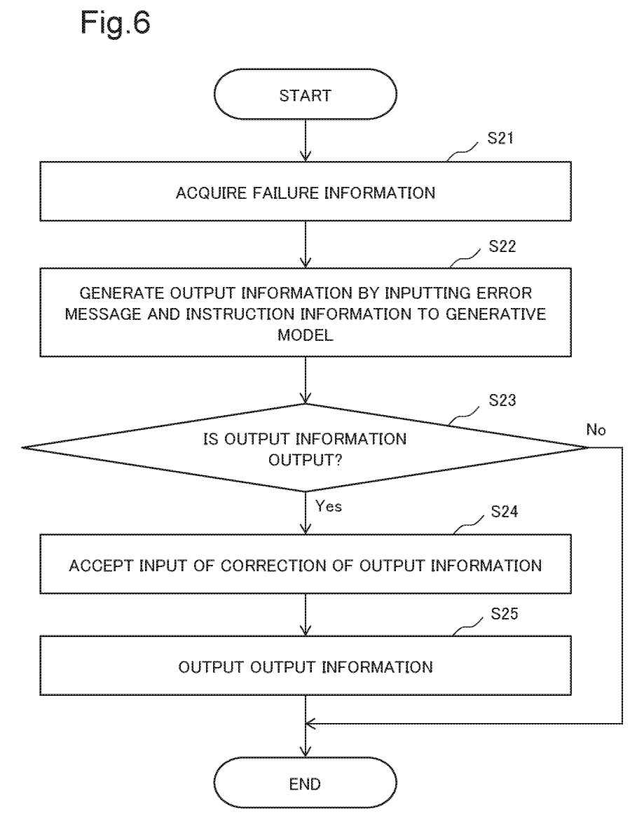

Next, an operation of the support device 20 will be described with reference to FIG. 6. FIG. 6 is a flowchart illustrating an example of the operation of the support device in the present disclosure. The generative model used by the support device of the present example embodiment is a model previously adjusted by the model adjustment unit 24.

First, the failure information acquisition unit 11 acquires failure information that is information regarding the failure occurring in the system (step S21). The processing of step S21 is the same as the processing of step S11 in the first example embodiment.

Next, the output information generation unit 12 generates the output information by inputting an error message and the instruction information to the generative model (step S22). The instruction information contains an instruction to predict the failure level indicating the level of the occurring failure.

Next, the determination unit 25 determines whether to output the output information to the user terminal 80 according to the level of the occurring failure (step S23). Upon determining that the output information is not output to the user terminal 80 (No in step S 23), the determination unit 25 ends the processing.

If it is determined that the output information is output to the user terminal 80 (Yes in step S23), the input request unit 26 accepts the input of the correction of the output information generated by the output information generation unit 12 (step S24).

Next, the output unit 13 outputs the output information (step S25). If the output information is corrected in step S24, the output unit 13 outputs the corrected output information. Upon the processing of step S25 is finished, the support device 20 ends the series of processing described above.

The support device of the present example embodiment is configured as described above. The support device in the present example embodiment has the following effects in addition to the effects obtained from the support device of the first example embodiment.

The support device of an aspect of the present example embodiment further includes the determination unit that determines whether to output the output information. The output information generation unit generates the output information containing the failure level by further inputting, to the generative model, the instruction to predict the failure level indicating the level of the failure. The determination unit determines whether to output the output information according to the failure level. This enables only highly important and/or urgent information to be effectively output to the user, so that a burden on the user is mitigated.

The support device of an aspect of the present example embodiment further includes the input request unit that accepts the input of the correction of the output information. Information output from the generative model is not necessarily correct, and in some cases, it is difficult for a person without specialized knowledge to determine the correctness of the information. According to the support device of the aspect of the present example embodiment, the output information can be output to the system administrator’s terminal and the correction input from the system administrator can be accepted, which makes it possible to improve the prediction accuracy of the output information provided to the user.

The support device of an aspect of the present example embodiment further includes the model adjustment unit that tunes the generative model using the training data in which the error messages issued at the time of the occurrence of the past failures are associated with the information regarding the impacts on the service caused by the failures. Tuning the model using the actual past failure cases enables the prediction accuracy to be improved.

### Third example embodiment

In the present example embodiment, a support device 30 having a configuration in which the support devices in the first example embodiment and the second example embodiment are simplified will be described. In the following description, description of parts similar to those in the first example embodiment and the second example embodiment will be omitted as appropriate.

### Configuration

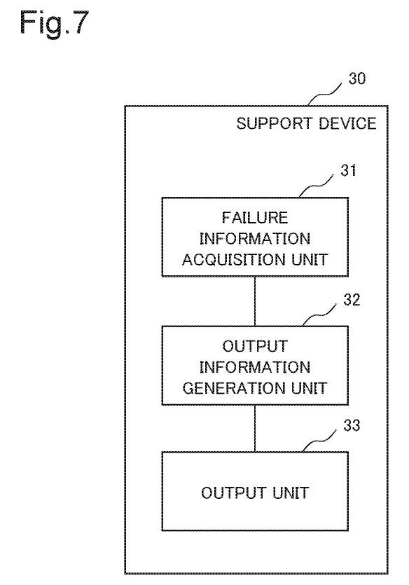

Description will be given regarding the configuration of the support device in the present example embodiment, with reference to FIG. 7. FIG. 7 is a block diagram illustrating an example of the configuration of the support device in the present disclosure. The support device 30 includes a failure information acquisition unit 31, an output information generation unit 32, and an output unit 33.

The failure information acquisition unit 31 acquires an error message output from a system in which a failure is occurring. The output information generation unit 32 generates output information by inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term. The output unit 33 outputs the output information.

### Operation

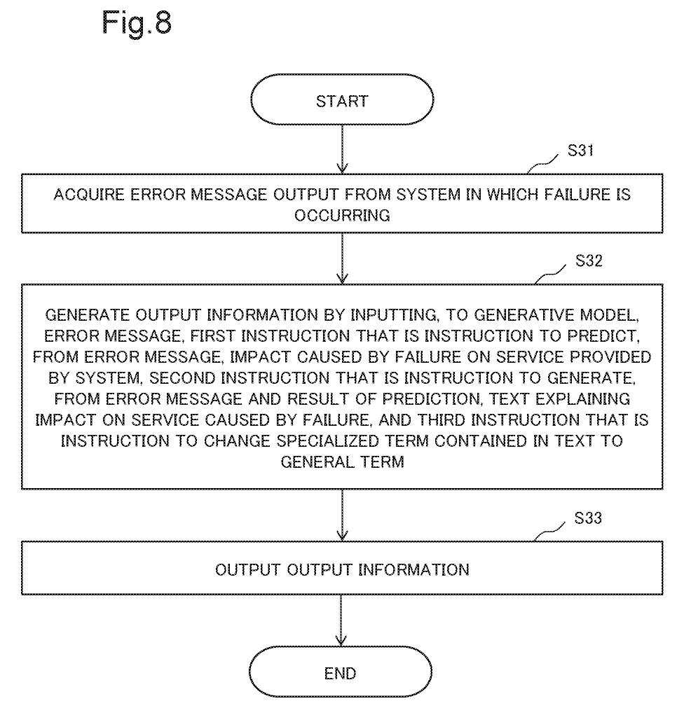

Next, description will be given regarding an example of an operation of the support device in the present example embodiment, with reference to FIG. 8. FIG. 8 is a flowchart illustrating the example of the operation of the support device in the present disclosure.

First, the failure information acquisition unit 31 acquires the error message output from the system in which the failure is occurring (step S31).

Next, the output information generation unit 32 generates the output information by inputting, to the generative model, the error message, the first instruction that is the instruction to predict, from the error message, the impact caused by the failure on the service provided by the system, the second instruction that is the instruction to generate, from the error message and the result of the prediction, the text explaining the impact on the service caused by the failure, and the third instruction that is the instruction to change the specialized term contained in the text to the general term (step S32).

Next, the output unit 33 outputs the output information (step S33).

The support device of the present example embodiment is configured as described above. The output information generated by the support device of the present example embodiment contains the text based on the prediction result of the impact caused by the failure on the service provided by the system, and the text does not contain the specialized term. This enables the support device of the present example embodiment to support, at the time of the occurrence of the system failure, a user without specialized knowledge in grasping the impact expected while the failure continues.

### Hardware configuration

Each component described above in each example embodiment of the present disclosure can be achieved as hardware and further achieved by a computing device or firmware based on program control.

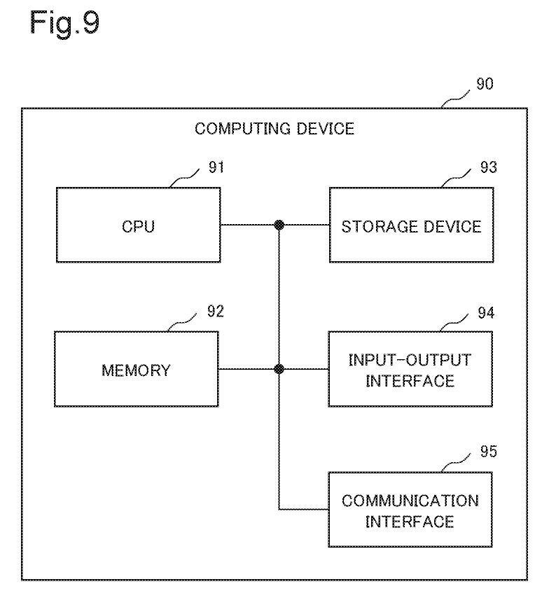

FIG. 9 is a diagram illustrating an example of a hardware configuration in which the support device in the present disclosure is achieved by a computing device 90 including a processor. The support device of each example embodiment is achieved by the computing device 90. As illustrated in FIG. 9, the computing device 90 includes a processor 91, a memory 92, a storage device 93, such as a hard disk, that stores a program, an input-output interface 94 for connection to an input device and an output device, and a communication interface 95 for network connection.

The processor 91 loads programs (commands) stored in the storage device 93 and the like into the memory 92. For example, the programs are software programs for executing control and processing in the present disclosure. The processor 91 executes the programs loaded into the memory 92. The processor 91 executes the control and the processing in the present disclosure by executing the programs.

Examples of the storage device 93 include an optical disc, a flexible disk, a magneto-optical disk, an external hard disk, and a semiconductor memory. Some of storage media included in the storage device are non-volatile storage devices, and record therein programs. The programs may be downloaded from an external computer (not illustrated) connected to a communication network.

The input device connected to the input-output interface 94 is achieved by a mouse or a keyboard, for example, and is used for input operation. Similarly, the output device connected to the input-output interface 94 is achieved by a display, for example, and is used for display and check of an output result.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

One, some, or all of the above example embodiments can also be described as Supplementary Notes below.

### Supplementary Note 1

A support device including:

failure information acquisition means for acquiring an error message output from a system in which a failure has occurred;

output information generation means for generating output information by inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term; and

output means for outputting the output information.

### Supplementary Note 2

The support device according to Supplementary Note 1, in which the first instruction further contains an instruction to predict a suspension period indicating a period during which the service is unavailable due to the failure.

### Supplementary Note 3

The support device according to Supplementary Note 1, in which

a plurality of the services are provided, and

the first instruction further contains an instruction to predict the service that becomes unavailable due to the failure and the service that is still available if the failure is occurring.

### Supplementary Note 4

The support device according to Supplementary Note 1, in which

the failure information acquisition means further acquires monitoring data collected by monitoring a resource being a monitoring target in the system,

the first instruction is an instruction to predict, further based on the monitoring data, the impact on the service caused by the failure, and

the second instruction is an instruction to generate the text further based on the monitoring data.

### Supplementary Note 5

The support device according to Supplementary Note 1, in which the output information generation means generates the output information by further inputting, to the generative model, a contract document concerning the system and an instruction to perform, by comparing a content of the contract document with the prediction result by the first instruction, prediction of whether the failure is within an extent of liability of a provider of the system.

### Supplementary Note 6

The support device according to Supplementary Note 1, further including determination means for determining whether to output the output information, in which

the output information generation means generates the output information containing a failure level indicating a level of the failure by further inputting, to the generative model, an instruction to predict the failure level, and

the determination means determines whether to output the output information according to the failure level.

### Supplementary Note 7

The support device according to Supplementary Note 1, further including input request means for accepting an input of a correction of the output information.

### Supplementary Note 8

The support device according to Supplementary Notes 1 to 7, further including model adjustment means for tuning the generative model using training data in which an error message issued at the time of occurrence of a past failure is associated with information regarding an impact on the service caused by the failure.

### Supplementary Note 9

A support method executed by a computer, including:

acquiring an error message output from a system in which a failure has occurred;

inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term;

acquiring, as output information, information output from the generative model; and

outputting the output information.

### Supplementary Note 10

A computer program causing a computer to execute processing including:

acquiring an error message output from a system in which a failure has occurred;

generating output information by inputting, to a generative model, the error message, a first instruction that is an instruction to predict, from the error message, an impact caused by the failure on a service provided by the system, a second instruction that is an instruction to generate, from the error message and a result of the prediction, text explaining the impact on the service caused by the failure, and a third instruction that is an instruction to change a specialized term contained in the text to a general term; and

outputting the output information.

In Supplementary Notes described above, one, some, or all of the configurations described in Supplementary Notes 2 to 8 dependent from Supplementary Note 1 can also be dependent from Supplementary Notes 9 and 10 in accordance with the same dependency relation as in Supplementary Notes 2 to 8. Further, one, some, or all of the configurations described as the Supplementary Notes can be similarly dependent from not only Supplementary Notes 1, 9, and 10 but also various pieces of hardware and various systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A support device comprising:
one or more memories storing instructions; and
one or more processors configured to execute the instructions to:
acquire an error message output from a system in which a failure has occurred;
generate output information by inputting, to a generative model, the error message, a first instruction, a second instruction, and a third instruction, the first instruction being an instruction to predict, from the error message, an impact caused by the failure on a service provided by the system, the second instruction being an instruction to generate, from the error message and a result of the prediction, text explaining the impact on the service caused by the failure, the third instruction being an instruction to change a specialized term contained in the text to a general term; and
output the output information.

2. The support device according to claim 1, wherein the first instruction further contains an instruction to predict a suspension period indicating a period during which the service is unavailable due to the failure.

3. The support device according to claim 1, wherein
a plurality of the services are provided, and
the first instruction further contains an instruction to predict the service that becomes unavailable due to the failure and the service that is still available if the failure is occurring.

4. The support device according to claim 1, wherein
the one or more processors are further configured to execute the instructions to acquire monitoring data collected by monitoring a resource being a monitoring target in the system,
the first instruction is an instruction to predict, further based on the monitoring data, the impact on the service caused by the failure, and
the second instruction is an instruction to generate the text further based on the monitoring data.

5. The support device according to claim 1, wherein the one or more processors are configured to execute the instructions to generate the output information by further inputting, to the generative model, a contract document concerning the system and an instruction to perform, by comparing a content of the contract document with the prediction result by the first instruction, prediction of whether the failure is within an extent of liability of a provider of the system.

6. The support device according to claim 1, wherein
the one or more processors are further configured to execute the instructions to:
generate the output information containing a failure level indicating a level of the failure by further inputting, to the generative model, an instruction to predict the failure level; and
determine whether to output the output information according to the failure level.

7. The support device according to claim 1, wherein the one or more processors are further configured to execute the instructions to accept an input of a correction of the output information.

8. The support device according to claim 1, the one or more processors are further configured to execute the instructions to tune the generative model using training data in which an error message issued at the time of occurrence of a past failure is associated with information regarding an impact on the service caused by the failure.

9. The support device according to claim 1, wherein the generative model is a trained machine learning model.

10. The support device according to claim 1, wherein the generated text explaining the impact of the failure supports user's decision making on how to respond to the failure.

11. A support method comprising:
by a computer,
acquiring an error message output from a system in which a failure has occurred;
inputting, to a generative model, the error message, a first instruction, a second instruction, and a third instruction, the first instruction being an instruction to predict, from the error message, an impact caused by the failure on a service provided by the system, the second instruction being an instruction to generate, from the error message and a result of the prediction, text explaining the impact on the service caused by the failure, the third instruction being an instruction to change a specialized term contained in the text to a general term;
acquiring, as output information, information output from the generative model; and
outputting the output information.

12. A non-transitory recording medium storing thereon a computer program causing a computer to execute:
acquiring an error message output from a system in which a failure has occurred;
generating output information by inputting, to a generative model, the error message, a first instruction, a second instruction, and a third instruction, the first instruction being an instruction to predict, from the error message, an impact caused by the failure on a service provided by the system, the second instruction being an instruction to generate, from the error message and a result of the prediction, text explaining the impact on the service caused by the failure, the third instruction being an instruction to change a specialized term contained in the text to a general term; and
outputting the output information.
